(19) United States
(12) Patent Application Publication
(10) Pub. No.: US 2023/0306344 A1
(43) Pub. Date: Sep. 28, 2023

(54) INFORMATION MANAGEMENT APPARATUS, INFORMATION MANAGEMENT METHOD, AND PROGRAM

(71) Applicant: Nippon Telegraph and Telephone Corporation, Tokyo (JP)

(72) Inventors: Tsuyoshi Toyoshima, Musashino-shi, Tokyo (JP); Kensuke TAKAHASHI, Musashino-shi, Tokyo (JP)

(21) Appl. No.: 18/018,636

(22) PCT Filed: Jul. 31, 2020
(86) PCT No.: PCT/JP2020/029426

§ 371 Date: Jan. 30, 2023

(51) Int. Cl. G06Q 10/0637; G06Q 10/0631

(52) U.S. Cl. CPC G06Q 10/0637; G06Q 10/06312

(57) ABSTRACT

A blockchain service system 1 manages information related to an operation associated with provision of a service. The blockchain service system 1 includes the basic ledger 131 that is shared between a service provider and a service user in the blockchain network 200 and records a core ID indicating management information related to a management object, the operation ledger 132 that is shared between providers in the blockchain network 100 and records operation information related to an operation associated with the management information by the core ID, a blockchain generation unit which receives information on an operation to be executed for the management object, generates operation information to be recorded in the operation ledger 132, and assigns the core ID associated with the management information to the operation information, and a ledger management unit 13 that records the core ID in the basic ledger 131 and records the operation information to which the core ID has been assigned in the operation ledger 132.

### TECHNICAL FIELD

The present invention relates to an information management device, an information management method, and a program.

### BACKGROUND ART

In the blockchain technology proposed in NPL 1, high availability and data identity (alteration prevention) are realized without intensively managing data by causing a large number of nodes distributed on a network to hold ledger data. Blockchain technology has been used in various industries such as finance, real estate, and games.

### CITATION LIST

### Non Patent Literature

[NPL 1] Satoshi Nakamoto, “Bitcoin: A Peer-to-Peer Electronic Cash System”

### SUMMARY OF INVENTION

### Technical Problem

It is considered possible to automate operations performed by many people and reduce operations performed by people by applying a blockchain mechanism and constructing a blockchain network for managing information handled in an operation field. Applicable operation fields include industrial operations such as electricity/gas/water, transportation, information communication, and services. An operation is a manual operation process regardless of a service user and a service provider. For example, as operations, there are customer management for managing information on users, contract processing when a user starts service use, facility construction for service use after contract conclusion, charge determination processing for service use, charge billing processing, processing of maintenance such as failure and monitoring after start of service use, and processing of providing use information of each service.

However, in the case of managing data of an operation in the ledger of blockchain, a user can equally use ledger information, and thus there is a problem that it is not suitable for handling data requiring confidentiality.

The present invention has been made in view of the above, and an object of the present invention is to enable automation of operations and labor saving while maintaining confidentiality of data when the blockchain technology is applied to operation fields.

### Solution to Problem

An information management device of one aspect of the present invention is an information management device for managing information related to an operation associated with provision of a service, including: a basic ledger that is shared between a service provider and a service user in a first blockchain network and records a management information identifier indicating management information related to a management object; an operation ledger that is shared between providers in a second blockchain network and records operation information related to the operation associated with the management information by the management information identifier; a generation unit that receives information on an operation to be executed for the management object, generates operation information to be recorded in the operation ledger, and assigns the management information identifier associated with the management information to the operation information; and a recording unit that records the management information identifier in the basic ledger and records the operation information to which the management information identifier has been assigned in the operation ledger.

An information management method of one aspect of the present invention is an information management method executed by an information management device for managing information related to an operation associated with provision of a service, the information management device including: a basic ledger that is shared between a service provider and a service user in a first blockchain network and records a management information identifier indicating management information related to a management object; and an operation ledger that is shared between providers in a second blockchain network and records operation information related to the operation associated with the management information by the management information identifier, the information management method including: receiving information on an operation to be executed for the management object, generating operation information to be recorded in the operation ledger, and assigning the management information identifier associated with the management information to the operation information; and recording the management information identifier in the basic ledger and recording the operation information to which the management information identifier has been assigned in the operation ledger.

### Advantageous Effects of Invention

According to the present invention, it is possible to enable automation of operations and labor saving while maintaining confidentiality of data when the blockchain technology is applied to operation fields.

### BRIEF DESCRIPTION OF DRAWINGS

FIG. 1 is a diagram showing an example of an overall configuration of a blockchain service system of the present embodiment.

FIG. 2 is a diagram showing an example of a configuration of the blockchain service system of the present embodiment.

FIG. 3 is a diagram showing an example of a configuration of a block generation unit.

FIG. 4A is a diagram showing an example of information handled by each unit of the blockchain service system.

FIG. 4B is a diagram showing an example of information handled by each unit of the blockchain service system.

FIG. 5 is a diagram illustrating an example of a data-related diagram.

FIG. 6 is a sequence diagram showing an example of a flow of processing of the blockchain service system of the present embodiment.

FIG. 7 is a diagram showing an example of the blockchain service system of the present embodiment.

FIG. 8 is a diagram showing an example of a hardware configuration of the blockchain service system.

### DESCRIPTION OF EMBODIMENTS

Hereinafter, an embodiment of the present invention will be described using the drawings.

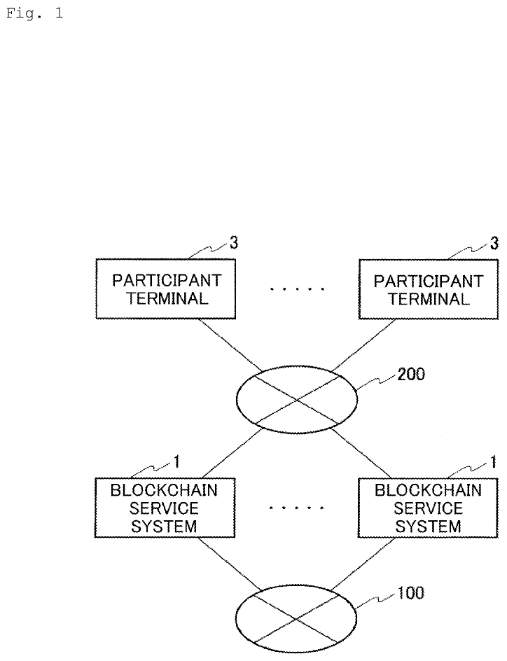

FIG. 1 is a diagram showing an overall configuration of a blockchain service system of the present embodiment. A blockchain network 100 is configured by blockchain service systems 1 held by service providers. The blockchain network is a network in which devices are connected by P2P and a ledger is shared between the devices. The ledger is history information in which blocks encrypted by the blockchain technology have been managed as a chain. A blockchain network 200 is composed of blockchain service systems 1 and participant terminals 3. Users and providers of services install an application (software) in the participant terminals 3, register management information thereof in the blockchain, and participate in the blockchain network 200. A provider is a person or a machine that provides a service. A user is a person or a machine that uses a provided service. A provider and a user are both called participants.

In the blockchain network 100, information handled in an operation (hereinafter referred to as operation information) is shared as an operation ledger between blockchain service systems 1. The operation ledger is a ledger shared in the blockchain network 100. In the present embodiment, as examples of operations, customer management, contract management, facility management, construction management, charge management, billing management, maintenance management, and use management are assumed. In customer management, information of participants is managed. In contract management, contract information of a user is managed. In facility management, information of a facility providing a service is managed. In construction management, connection of information managed by customer management and facility management is managed. In charge management, details of a charge for service use are managed. In billing management, details of payment of charge are managed. In maintenance management, monitoring of individual customer-managed information and incident information are managed. In use management, information using a service is managed. Information managed by each operation is recorded in the operation ledger.

In the blockchain network 200, management information composed of physical and logical information of a user and a provider is shared by the participant terminals 3 and the blockchain service systems 1 as a basic ledger. The basic ledger is a ledger shared in the blockchain network 200. The management information is information for assigning a core ID to a management object to substantialize the management object and identifying it as data regardless of a physical space or a virtual space. For example, the management information is information for identifying a physical device such as an apparatus or a terminal, a service (SaaS, PaaS, IaaS) of the information communication industry, or data handled as information in a virtual space. The management information includes personal information such as the name of a participant, and information associated with product information provided by a provider and used by a user.

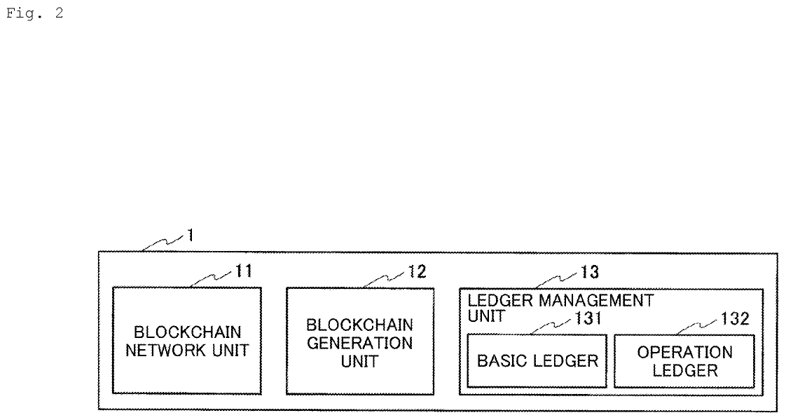

The blockchain service system 1 of the present embodiment will be described with reference to FIG. 2. The blockchain service system 1 of FIG. 2 includes a blockchain network unit 11, a blockchain generation unit 12, and a ledger management unit 13.

The blockchain network unit 11 has a function of controlling participation of users and providers in a blockchain network and a function of generating/collecting operation information. In the present embodiment, management information is managed by an identity ID, the management information is caused to participate in the blockchain network by a core ID, and the management information is associated with operation information as the core ID. The identity ID is a unique ID in the blockchain network. The core ID is a unique ID indicating the management information and is an ID for associating the operation information with the management information.

The blockchain network unit 11 performs identity management and participation management by assigning an identity ID to a participant. For example, the owner ID and certificate of a participant and personal information of the participant are managed by the identity ID. The owner ID and the certificate are generated in the participant terminal 3. Participation is managed in order to secure the uniqueness of the core ID for the identity ID of the participant.

The blockchain network unit 11 receives information related to an operation to be executed on a management object from the participant terminal 3, generates and collects operation information (including information managed by a ledger) in units of management information, and transmits the operation information to the blockchain generation unit 12. For example, the blockchain network unit 11 collects personal information of participants as management information if necessary, and includes the personal information in operation information.

The blockchain network unit 11 may change, add, and delete the identity ID and the core ID through application operation of the terminal of the participant.

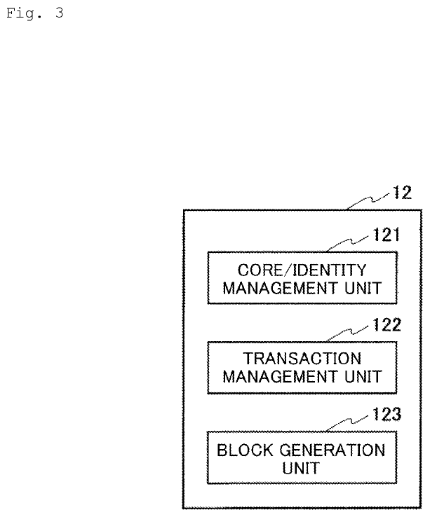

As shown in FIG. 3, the blockchain generation unit 12 includes a core/Identity management unit 121, a transaction management unit 122, and a block generation unit 123.

The core/identity management unit 121 assigns a core ID and a time stamp to an identity ID for identifying a participant in order to associate an operation to be executed with a management object. The core ID is returned to the participant terminal 3 via the blockchain network unit 11. The core/identity management unit 121 manages an identity ID, an owner ID, and a certificate in a set in association with a core ID.

The transaction management unit 122 generates transaction information associated with a core ID from operation information. The transaction information is information distributed in a basic ledger and an operation ledger. The transaction management unit 122 identifies information distributed in the basic ledger and information distributed in the operation ledger in the transaction information. The transaction management unit 122 assigns an owner ID to the transaction information. The participant having the assigned owner ID can refer to the transaction information.

An example of transaction information distributed in the operation ledger will be described below. Transaction information related to a customer management operation includes an identity ID indicating personal information of a user. Transaction information related to a contract management operation, a facility management operation, and a construction management operation includes fulfillment information of content to be set. Transaction information related to a charge management operation and a billing management operation includes billing information. Transaction information related to a maintenance management operation includes maintenance information. Transaction information related to a use management operation includes use information. Transaction information related to each operation is information (transaction, evidence, and exchange) generated by an activity in the blockchain network and is information distributed in the operation ledger. The transaction information related to each operation is registered in the operation ledger to constitute a customer ledger, a contract ledger, a facility ledger, a construction ledger, a charge billing ledger, a maintenance ledger, and a use ledger.

In the basic ledger, a core ID and history information are distributed as information indicating management information. The history information is history information (transactions, evidence, and exchange) generated by activities in the blockchain network for management information of participants. The management information and the operation information are associated with each other by the core ID, and the user can confirm execution of the operation by referring to the basic ledger and confirming information (transaction) including the core ID returned from the blockchain service system 1. For example, after the user operates the participant terminal 3 to use the blockchain service system 1 to execute an operation for changing the content of a contract, the user can refer to the basic ledger through the participant terminal 3, and if a history including the returned core ID is recorded in the basic ledger, confirm completion of contract change. Similarly, a provider can confirm an activity state of the user in the blockchain network by the basic ledger. Further, the provider and the user can confirm that the provider has executed an operation such as a change operation on management information.

The block generation unit 123 generates a block including management information distributed in the basic ledger and a block including operation information distributed in the operation ledger with reference to transaction information generated by the transaction management unit 122 and transmits the generated blocks to the ledger management unit 13. Specifically, the block generation unit 123 generates a block including transaction data, a hash value of a previous block, and nonce (a hash value of a current block) by applying the technology disclosed in NPL 1. The transaction data is encrypted with a public key of a transaction recipient.

The ledger management unit 13 manages two ledgers, a basic ledger 131 shared by all participants and an operation ledger 132 shared by providers.

The ledger management unit 13 registers the block of the operation ledger received from the blockchain generation unit 12 in the operation ledger 132. The ledger management unit 13 registers the block of the basic ledger in the basic ledger 131 after registering the block in the operation ledger 132. The ledger management unit 13 connects new blocks to previous blocks of the basic ledger 131 and the operation ledger 132 and registers the blocks in the ledgers, as in the technology of NPL 1.

Blocks of the basic ledger and blocks of the operation ledger are also distributed to other blockchain service systems 1 participating in the blockchain network and registered in the basic ledgers 131 and the operation ledgers 132 of the other block chain service systems 1. When there is update information to a ledger for management information of a participant, the update information is also distributed to an application of the participant terminal 3 participating in the blockchain network and registered in information held by the application of the participant terminal 3.

As an example of the information held by the application of the participant terminal 3, there is personal information. Two methods of registering management information for personal information may be conceived. These are a case where the personal information is registered in a ledger (any one or both of the basic ledger and the operation ledger) and a case where the personal information is not registered in the ledger. In the former registration method, a user assigns an owner ID to a provider at the time of participating in the blockchain network in units of personal information (management information). Ledgers can be referred to according to the owner ID. In the latter registration method, a user assigns an owner ID to a provider at the time of participating in the blockchain network in units of personal information (management information), permits access to personal information in an application in a participant terminal 3, and manages only an access history in ledgers. In both registration methods, the owner ID of the user is assigned to the provider, and the provider can refer to the personal information of the assigned owner ID. Further, the provider may assign the owner ID of the provider to the user. The user can refer to management information of the assigned owner ID. For example, by the provider assigning the owner ID to the user, the user can refer to management information related to a product provided by the provider.

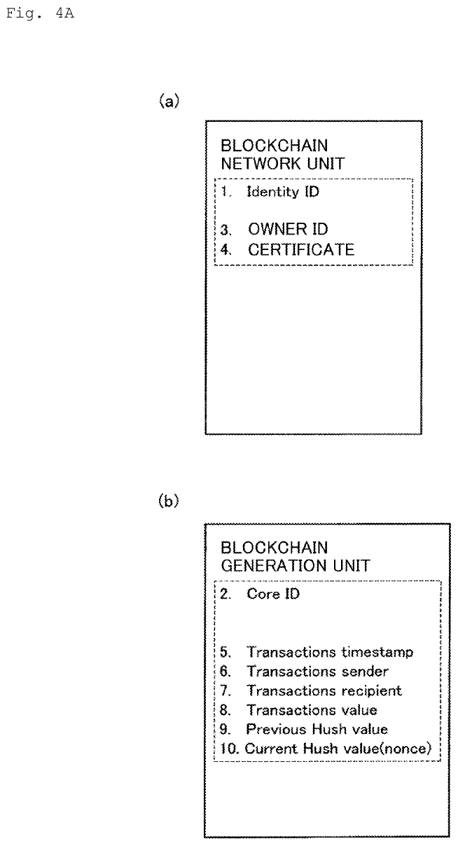

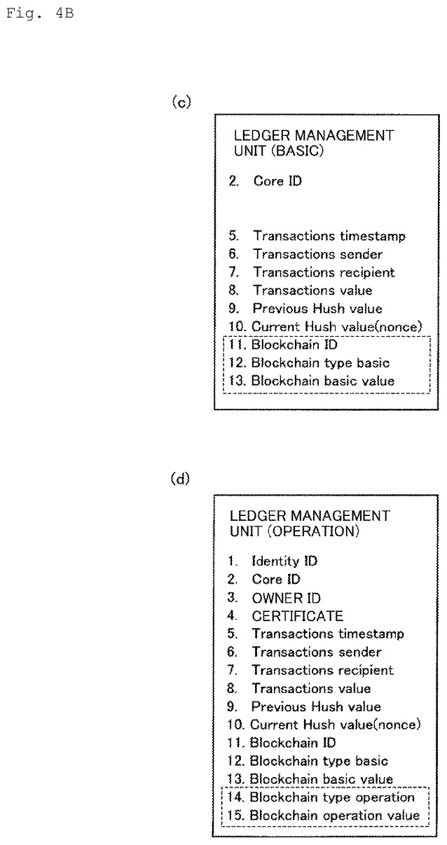

Information handled by each unit of the blockchain service system 1 will be described with reference to FIG. 4A and FIG. 4B. Information surrounded by broken lines in the figures is information generated or acquired by a corresponding unit.

In the blockchain network unit 11, an identity ID is assigned to an owner ID and a certificate.

In the blockchain generation unit 12, transaction information is generated from operation information received from the blockchain network unit 11.

In the basic ledger 131, the ID of a blockchain, the kind of the blockchain, and the value of the blockchain are assigned to a block including transaction information to be registered in the basic ledger. For example, information types such as basic and operation are assigned as ledgers to the type of a blockchain net.

In the operation ledger 132, an identity ID, an owner ID, a certificate, the type of a blockchain, and the value of the blockchain are assigned to a block including transaction information to be registered in the operation ledger, the ID of a blockchain of a block of the basic ledger, the type of the blockchain, and the value of the blockchain. For example, information types such as basic and operation are assigned as ledgers to the type of the blockchain. When the type of the blockchain is an operation, for example, an operation information type such as a customer, a contract, a facility, a construction, a charge, billing, a fault, or a use is assigned.

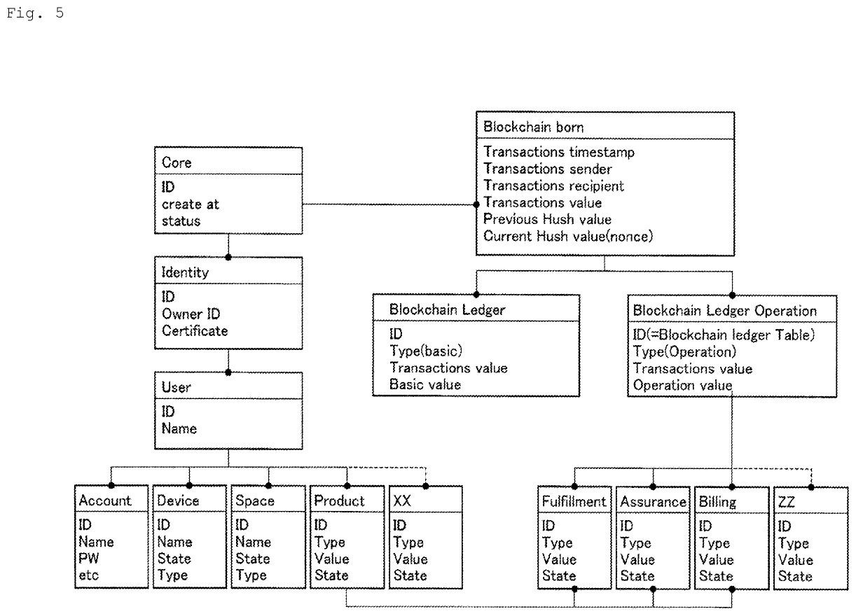

FIG. 5 shows an example of a data-related diagram from generation of a blockchain to generation of a basic ledger and an operation ledger by a user or a provider participating in a blockchain network.

For example, the user registers management information from the participant terminal 3 in order to execute a customer management operation for registering the user himself/herself. The management information registered by the user includes, for example, user information, account information, device information, and space information. When the provider registers himself/herself, product information to be provided may be included as management information. Individual piece of management information associated with a participant can be extended. An owner ID and a certificate are transmitted to the blockchain service system 1 from the participant terminal 3, and an identity ID is assigned to the management information. Personal information such as user information, account information, device information, and space information associated with the identity ID may be held by the participant terminal 3 or may be held in a ledger.

The blockchain service system 1 generates a transaction (Blockchain born in the figure) in association with a core ID and registers it in a basic ledger (Blockchain Ledger in the figure) and an operation ledger (Blockchain Ledger Operation in the figure). The block of the operation ledger includes operation information. The operation information includes, for example, fulfillment information, assurance information, and billing information in TMF (eTOM). The operation information can be extended according to an operation process. In the case of a customer management operation, the operation information includes an identity ID as customer information.

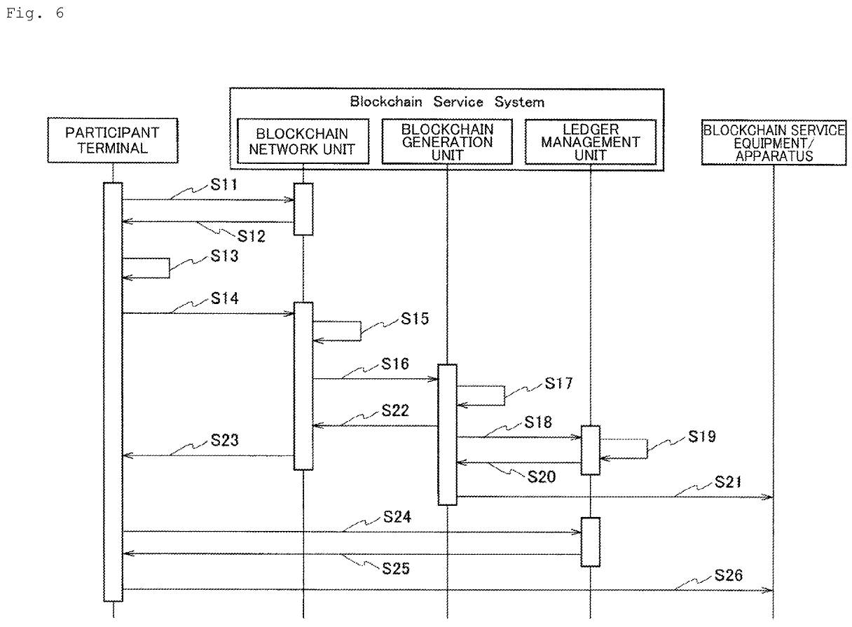

Next, a flow of processing of the blockchain service system 1 of the present embodiment will be described with reference to FIG. 6.

In steps S11 and S12, the participant terminal 3 accesses the blockchain service system 1 and downloads an application using the blockchain service system 1.

In step S13, the participant terminal 3 installs the application. After installation of the application, an owner ID and a certificate are automatically generated by the application.

In step S14, when the participant registers management information using the application and executes a customer management operation, the participant terminal 3 transmits the owner ID, the certificate, and information of the customer management operation to the blockchain service system 1.

In step S15, the blockchain network unit 11 generates an identity ID for managing the identity of the participant, manages participation, and collects information necessary for the customer management operation. For example, the information necessary for the customer management operation is input by the participant through the application of the participant terminal 3 or acquired from an external device.

In step S16, the blockchain network unit 11 transmits the identity ID and the operation information to the blockchain generation unit 12.

In step S17, the blockchain generation unit 12 generates a core ID associated with the identity ID, generates transaction information related to the operation in association with the core ID, and generates a block to be registered in a basic ledger and a block to be registered in an operation ledger.

In step S18, the blockchain generation unit 12 transmits the generated blocks to the ledger management unit 13.

In step S19, the ledger management unit 13 registers the blocks in the basic ledger and the operation ledger. The blocks are also distributed to other blockchain service systems 1.

In step S20, the ledger management unit 13 notifies the blockchain generation unit 12 that the blocks have been registered.

In step S21, the blockchain service system 1 sets equipment and an apparatus if necessary. The provider may perform a work with reference to the information registered in the operation ledger.

The core ID generated in step S17 is returned to the blockchain network unit 11 in step S22 and returned to the participant terminal 3 in step S23.

The participant selects a use menu from the application and refers to the basic ledger in step S24, and confirms that the blockchain service can be used in step S25.

In step S26, the participant starts to use the blockchain service.

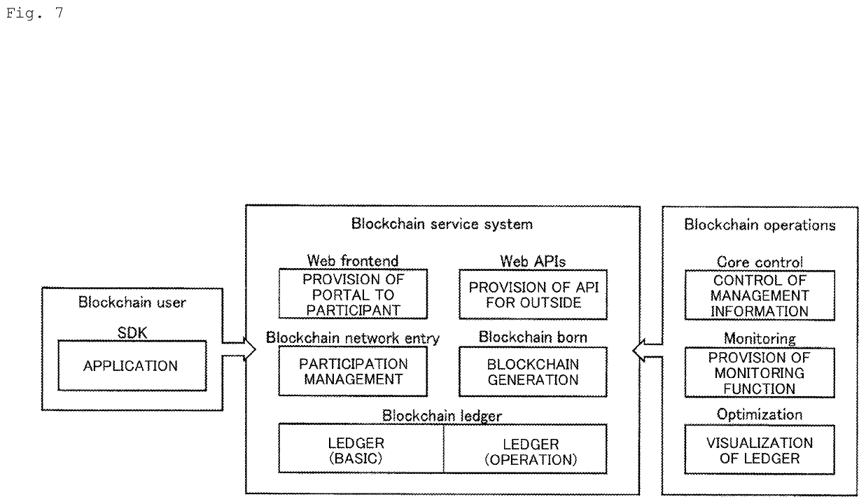

An example of the blockchain service system of the present embodiment will be described with reference to FIG. 7.

A blockchain user on the left side in the figure is software provided to a user by a provider. The user installs the software in a portable terminal or a personal computer and causes it to serve as a participant terminal 3. The software has a function of registering product information or service information necessary for the provider to construct the blockchain service.

A blockchain service system in the middle of the figure is a system having the function of the blockchain service system 1 of the present embodiment and includes a front end (web front end) that provides a portal to a participant, an API (web APIs) that provides a function of cooperating with this system to the outside, a blockchain network unit (blockchain network entry) that controls participation of a participants in a blockchain network, a blockchain generation unit (Blockchain born) that controls generation, change, and deletion of a blockchain, and a ledger management unit (Blockchain ledger) that manages a blockchain ledger.

Blockchain operations on the right side in the figure are software used by the provider to maintain the blockchain and includes a function (core control) of controlling management information, a function of monitoring the blockchain and the like, and a function (optimization) of visualizing transition and ledgers of the entire system.

As described above, the blockchain service system 1 according to the present embodiment includes the basic ledger 131 that is shared between a service provider and a service user in the blockchain network 200 and records a core ID indicating management information related to a management object, the operation ledger 132 that is shared between providers in the blockchain network 100 and records operation information related to an operation associated with the management information by the core ID, a blockchain generation unit which receives information on an operation to be executed for the management object, generates operation information to be recorded in the operation ledger 132, and assigns the core ID associated with the management information to the operation information, and a ledger management unit 13 that records the core ID in the basic ledger 131 and records the operation information to which the core ID has been assigned in the operation ledger 132. Accordingly, a core ID indicating management information and associated with an operation is shared and managed between a user and a provider in the basic ledger, and operation information is shared and managed between providers in the operation ledger, and thus confidentiality can be maintained. Further, since a participant can automatically execute an operation via software and confirm execution of the operation via the software by himself/herself, an unmanned operation can be performed and labor saving of the operation can be achieved.

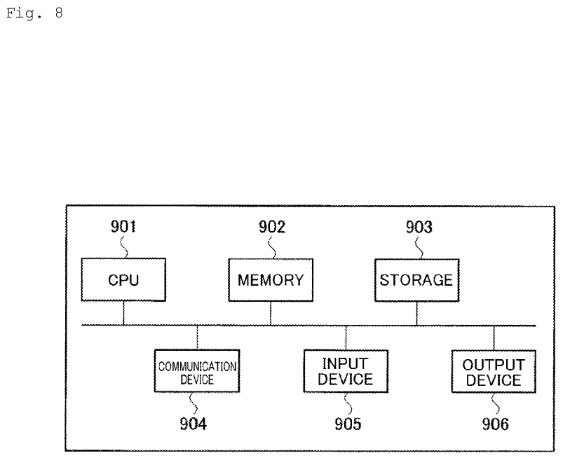

The blockchain service system 1 described above can use, for example, a general-purpose computer system including a central processing unit (CPU) 901, a memory 902, a storage 903, a communication device 904, an input device 905, and an output device 906, as shown in FIG. 8. In this computer system, the blockchain service system 1 is realized by the CPU 901 executing a predetermined program loaded to the memory 902. This program can be recorded on a computer-readable recording medium such as a magnetic disk, an optical disk, or a semiconductor memory, and can also be provided via a network. Each unit of the blockchain service system 1 may be realized by an individual computer system.

### REFERENCE SIGNS LIST

1 Blockchain service system
11 Blockchain network unit
12 Blockchain generation unit
121 Core/identity management unit
122 Transaction management unit
123 Block generation unit
13 Ledger management unit
131 Basic ledger
132 Operation ledger
3 Participant terminal
100, 200 Blockchain network

1. An information management device for managing information related to an operation associated with provision of a service, comprising:
a basic ledger that is shared between a service provider and a service user in a first blockchain network and in which a management information identifier indicating management information related to a management object is recorded;
an operation ledger that is shared between providers in a second blockchain network and in which operation information related to the operation associated with the management information by the management information identifier is recorded;
a generation unit, including one or more processors, configured to receive information on an operation to be executed for the management object, generates operation information to be recorded in the operation ledger, and assign the management information identifier associated with the management information to the operation information; and
a recording unit, including one or more processors, configured to record the management information identifier in the basic ledger and records the operation information to which the management information identifier has been assigned in the operation ledger.

2. The information management device according to claim 1, wherein
the recording unit is configured to record the management information identifier in the basic ledger after the operation information is recorded in the operation ledger.

3. The information management device according to claim 1, wherein
at least one of assignment of an owner identifier corresponding to the service provider to the service user and assignment of an owner identifier corresponding to the service user to the service provider is performed, and the service user or the service provider is permitted to refer to the management information according to the assigned owner identifier.

4. An information management method executed by an information management device for managing information related to an operation associated with provision of a service,
the information management device including:
a basic ledger that is shared between a service provider and a service user in a first blockchain network and in which a management information identifier indicating management information related to a management object is recorded; and
an operation ledger that is shared between providers in a second blockchain network and in which operation information related to the operation associated with the management information by the management information identifier is recorded,
the information management method comprising: receiving information on an operation to be executed for the management object, generating operation information to be recorded in the operation ledger, and assigning the management information identifier associated with the management information to the operation information; and
recording the management information identifier in the basic ledger and recording the operation information to which the management information identifier has been assigned in the operation ledger.

5. The information management method according to claim 4, wherein
the management information is recorded in the basic ledger after the operation information is recorded in the operation ledger.

6. The information management method according to claim 4, wherein
at least one of assignment of an owner identifier corresponding to the service provider to the service user and assignment of an owner identifier corresponding to the service user to the service provider is performed, and the service user or the service provider is permitted to refer to the management information according to the assigned owner identifier.

7. A non-transitory computer-readable storage medium storing a program for causing a computer to cause an information management device according to perform operations, the information management device including:
a basic ledger that is shared between a service provider and a service user in a first blockchain network and in which a management information identifier indicating management information related to a management object is recorded, and
an operation ledger that is shared between providers in a second blockchain network and in which operation information related to the operation associated with the management information by the management information identifier is recorded,
the operations comprising:
receiving information on an operation to be executed for the management object, generating operation information to be recorded in the operation ledger, and assigning the management information identifier associated with the management information to the operation information; and
recording the management information identifier in the basic ledger and recording the operation information to which the management information identifier has been assigned in the operation ledger.

8. The non-transitory computer-readable storage medium according to claim 7, wherein
the management information is recorded in the basic ledger after the operation information is recorded in the operation ledger.

9. The non-transitory computer-readable storage medium according to claim 7, wherein
at least one of assignment of an owner identifier corresponding to the service provider to the service user and assignment of an owner identifier corresponding to the service user to the service provider is performed, and the service user or the service provider is permitted to refer to the management information according to the assigned owner identifier.
